(19) United States
(12) Patent Application Publication
(10) Pub. No.: US 2021/0056670 A1
(43) Pub. Date: Feb. 25, 2021

(54) SYSTEM AND METHOD FOR AUTOMATICALLY CREATING COMBINED IMAGES OF A VEHICLE AND A LOCATION

(71) Applicant: TOYOTA MOTOR NORTH AMERICA, INC., PLANO, TX (US)

(72) Inventor: NARENDRAN NARAYANASAMY, Irvine, CA (US)

(21) Appl. No.: 16/544,006

(22) Filed: Aug. 19, 2019

(51) Int. Cl. G06T 5/50; G06T 7/00

(52) U.S. Cl. CPC G06T 5/50; G06T 7/0002; G06T 2207/30252; G06T 2207/30268; G06T 2207/20212

(57) ABSTRACT

Systems and methods are provided for automatically creating combined images of a vehicle and a location. An example method may include determining a location; obtaining a stock image of an environment related to the location; obtaining an image of the vehicle; generating a combined image, comprising combining the stock image of the environment with the image of the vehicle; and displaying the combined image.

### TECHNICAL FIELD

The present disclosure relates generally to vehicles, and in particular, some implementations may relate to vehicles that generate and display images.

### DESCRIPTION OF RELATED ART

Vehicle owners take pride in their vehicles, and often take photographs of them to share with others. To produce more memorable images, vehicle owners often photograph their vehicles in scenic locations. But obtaining such images can be a difficult and time-consuming process, and can require expensive equipment.

### BRIEF SUMMARY OF THE DISCLOSURE

Various embodiments of the disclosed technology provide for automatically creating combined images of a vehicle and a location.

In general, one aspect disclosed features a system, comprising: a hardware processor; and a non-transitory machine-readable storage medium encoded with instructions executable by the hardware processor to perform a method comprising: determining a location; obtaining a stock image of an environment related to the location; obtaining an image of the vehicle; generating a combined image, comprising combining the stock image of the environment with the image of the vehicle; and displaying the combined image.

Embodiments of the system may include one or more of the following features. In some embodiments, the location is a current location of the vehicle. In some embodiments, the image of the vehicle is a stock image of the vehicle. Some embodiments comprise capturing the image of the vehicle. Some embodiments comprise obtaining an image of person; wherein generating the combined image comprises combining the image of the environment, the image of the vehicle, and the image of the person. Some embodiments comprise capturing the image of the person. In some embodiments, the vehicle includes one or more cameras; and capturing the image of the person comprises capturing the image of the person using the one or more cameras of the vehicle.

In general, one aspect disclosed features a non-transitory machine-readable storage medium encoded with instructions executable by the hardware processor to perform a method comprising: determining a location; obtaining a stock image of an environment related to the location; obtaining an image of the vehicle; generating a combined image, comprising combining the stock image of the environment with the image of the vehicle; and displaying the combined image.

Embodiments of the method may include one or more of the following features. In some embodiments, the location is a current location of the vehicle. In some embodiments, the image of the vehicle is a stock image of the vehicle. Some embodiments comprise capturing the image of the vehicle. Some embodiments comprise obtaining an image of person; wherein generating the combined image comprises combining the image of the environment, the image of the vehicle, and the image of the person. Some embodiments comprise capturing the image of the person. In some embodiments, the vehicle includes one or more cameras; and capturing the image of the person comprises capturing the image of the person using the one or more cameras of the vehicle.

In general, one aspect disclosed features a method for a vehicle, comprising: determining a location; obtaining a stock image of an environment related to the location; obtaining an image of the vehicle; generating a combined image, comprising combining the stock image of the environment with the image of the vehicle; and displaying the combined image.

Embodiments of the method may include one or more of the following features. In some embodiments, the location is a current location of the vehicle. In some embodiments, the image of the vehicle is a stock image of the vehicle. Some embodiments comprise capturing the image of the vehicle. Some embodiments comprise obtaining an image of person; wherein generating the combined image comprises combining the image of the environment, the image of the vehicle, and the image of the person. Some embodiments comprise capturing the image of the person.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for automatically creating combined images of the vehicle and a location in accordance with one embodiment of the systems and methods described herein.

FIG. 3 illustrates a process for a vehicle for automatically creating combined images of the vehicle and a location according to embodiments of the disclosed technology.

FIG. 4 shows an example selfie mode user interface according to embodiments of the disclosed technology.

FIG. 5 illustrates an example stock image of Mount Fuji.

FIG. 6 illustrates scenarios where vehicle images are captured and then relayed to the vehicle according to embodiments of the disclosed technology.

FIG. 7 illustrates an example vehicle image.

FIG. 8 illustrates an example vehicle selfie.

FIG. 9 illustrates an example image of a person.

FIG. 10 illustrates an example vehicle selfie including the image of the person of FIG. 9.

FIG. 11 illustrates an example image of the interior of a vehicle.

FIG. 12 illustrates an example combined image of the interior of the vehicle shown in FIG. 11 combined with the image of Mount Fuji of FIG. 5.

FIG. 13 illustrates an example image of a person.

FIG. 14 illustrates an example vehicle selfie including the image of the interior of the vehicle of FIG. 11, the image of the person of FIG. 13, and the image of Mount Fuji of FIG. 5.

FIG. 15 is an example computing component that may be used to implement various features of embodiments described in the present disclosure.

The figures are not exhaustive and do not limit the present disclosure to the precise form disclosed.

### DETAILED DESCRIPTION

As mentioned above, vehicle owners like to take photographs of their vehicles in scenic locations, but this can be a difficult and expensive process, raising a number of technical challenges, as described below. Embodiments of the disclosed technology provide a way to simplify and automate this process to produce stunning “vehicle selfies.” As described in detail below, the disclosed embodiments implement an inventive concept that provides a novel approach to addressing the generation of such images that extends beyond conventional image generation operations and changes the operation of the computing system of the vehicle in a number of ways. Embodiments of the disclosed technology are described in terms of still images, such as photographs. However, other embodiments may employ moving images such as videos, drawings, and the like, either alone or in combination with still images.

In the disclosed embodiments, the vehicle may determine a location. In some embodiments, the location may be the current location of the vehicle, and may be determined using global positioning system (GPS) technology, or the like. In other embodiments, the location may be provided to the vehicle by the driver, or another occupant of the vehicle.

The vehicle may then obtain a stock image of an environment related to the location. As used herein, the term “stock image” generally refers to an image provided to the vehicle, rather than one captured by cameras of the vehicle. However, stock images may also be captured by one or more cameras of the vehicle as a vehicle travels or visits different locations, and these images may be stored for future use. This automatic operation of the computing system of the vehicle to obtain stock images of the environment of the vehicle provides several technical advantages over previous approaches. Stock images in some applications may be composed by, and captured by, professional photographers. The stock images may therefore be of high quality, high resolution, and the like. Furthermore, stock images are generally taken under ideal conditions. For example, Mount Fuji is often obscured by clouds, so complete photographs of the mountain may only be taken on certain days.

In the disclosed embodiments, the stock images are described as outdoor images. However, the stock images are not limited to outdoor images, and may include indoor images, and the like. In some embodiments, more than one stock image may be used. In such embodiments, the stock images may be used together in any manner. For example, stock images may be stitched together, juxtaposed, superimposed, and the like. In some embodiments, the stock images used together may represent multiple locations. In further embodiments, stock images are not limited to photographs or images taken with an image sensor, but may include scenes created with graphic systems such as by a digital graphics artist. In other embodiments, the stock image may be an analog image, for example such as a sketch, painting, or the like. In such embodiments, the analog image is converted to digital form prior to combining with other images.

An image of the vehicle may be obtained as well. In some embodiments, the image of the vehicle is a stock image. In other embodiments, the image of the vehicle may be captured by the vehicle or by the vehicle's owner, passengers or other persons. For example, an image of the interior of the vehicle may be captured by one or more cameras mounted inside the vehicle, by a person using a camera, or the like. Exterior images of the vehicle may be captured by handheld cameras, by cameras mounted on other vehicles, by automated roadside cameras, and the like, and may be provided to the vehicle by wireless transmission. In some embodiments, more than one vehicle image may be used. In such embodiments, the vehicle images may be used together in any manner. For example, the vehicle images may be combined, juxtaposed, superimposed, and the like.

The vehicle may generate a combined image of the location environment and the vehicle. That is, the vehicle may combine one or more of the stock images of the environment at the determined location with one or more images of the vehicle to create a vehicle selfie. For example, an image of the vehicle may be superimposed over an image of a scenic location. The images may be altered before, during, or after their combining. In various embodiments, this altering may include altering features of the images such as sizes, colors, resolutions, aspects, perspectives, lighting, and the like. For example, the lighting in the vehicle image may be altered to match the lighting in the image of the environment. The addition of these automatic operations to the operation of the computing system of the vehicle solves the technical problems faced in generating such images.

Sometimes, people like to be included in the photographs of their vehicles. Some embodiments of the disclosed technology provide this function as well. In such embodiments, the vehicle obtains one or more images of one or more persons. In some embodiments, the vehicle captures an image of a person using one or more cameras mounted on the vehicle. In other embodiments, the image of the person may be provided to the vehicle. For example, a person may transmit the image to the vehicle using a smart phone, or the like. In another example, a person may operate the head unit of the vehicle to obtain the image from storage at a remote location, such as a website or the like. In these embodiments, the vehicle may combine the images of the person, the vehicle, and the location environment, for example in the manner described above. In these embodiments, the operations of the computing system of the vehicle have been modified to obtain the novel feature of automatically including images of people in the combined image of the vehicle and its environment, thereby solving another technical problem encountered when generating such images.

After generating the combined image, the vehicle may share the combined image. For example, the vehicle may display the combined image on a display panel of the vehicle. As another example, the vehicle may transmit the image to one or more devices such as smart phones, transmit the image to one or more remote storage sites, post the image on a social media website, or the like.

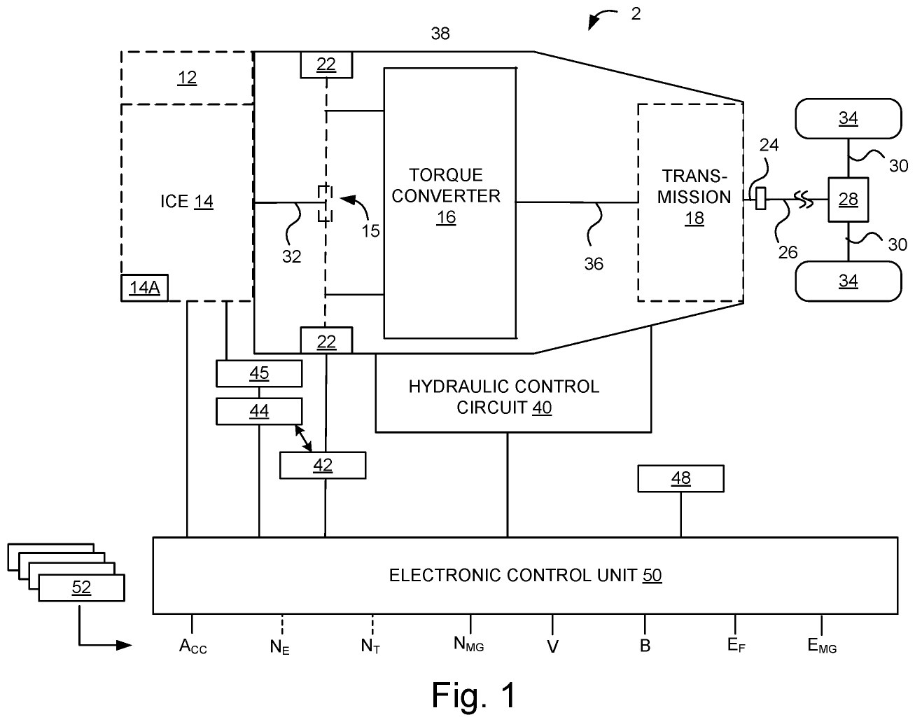

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for automatically creating combined images of the vehicle and a location can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. The instructions may be executed to capture and combine images, for example as described in detail herein. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MS}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc. The sensors 52 may include cameras to capture images inside the vehicle, as described herein in detail.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. The sensors 52 may include cameras to capture images outside the vehicle, as described herein in detail. While some sensors can be used to actively detect passive environmental objects, other sensors can be included and used to detect active objects such as those objects used to implement smart roadways that may actively transmit and/or receive data or other information.

The examples of FIG. 1 is provided for illustration purposes only as examples of vehicle systems with which embodiments of the disclosed technology may be implemented. One of ordinary skill in the art reading this description will understand how the disclosed embodiments can be implemented with vehicle platforms.

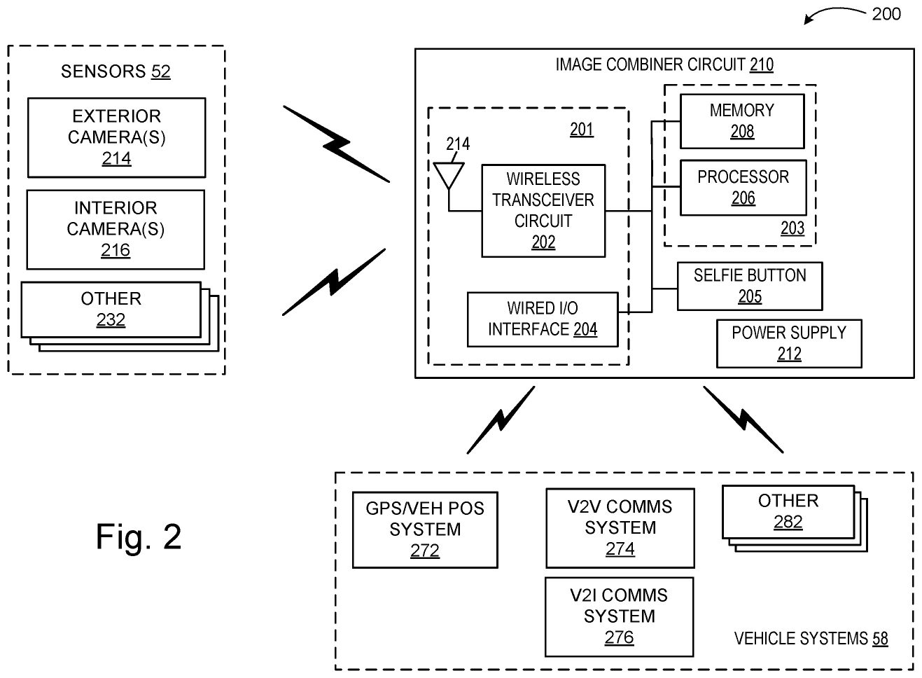

FIG. 2 illustrates an example architecture for automatically creating combined images of the vehicle and a location in accordance with one embodiment of the systems and methods described herein. Referring now to FIG. 2, in this example, a selfie system 200 includes a image combiner circuit 210, a plurality of sensors 52, and a plurality of vehicle systems 58. Sensors 52 and vehicle systems 58 can communicate with image combiner circuit 210 via a wired or wireless communication interface. Although sensors 52 and vehicle systems 58 are depicted as communicating with image combiner circuit 210, they can also communicate with each other as well as with other vehicle systems. Image combiner circuit 210 can be implemented as an ECU or as part of an ECU such as, for example electronic control unit 50. In other embodiments, image combiner circuit 210 can be implemented independently of the ECU.

Image combiner circuit 210 in this example includes a communication circuit 201, a decision circuit 203 (including a processor 206 and memory 208 in this example) and a power supply 212. Components of image combiner circuit 210 are illustrated as communicating with each other via a data bus, although other communication in interfaces can be included. Image combiner circuit 210 in this example also includes a selfie button 205 that can be operated by the user to manually select the selfie mode.

Processor 206 can include a GPU, CPU, microprocessor, or any other suitable processing system. The memory 208 may include one or more various forms of memory or data storage (e.g., flash, RAM, etc.) that may be used to store instructions and variables for processor 206 as well as any other suitable information. Memory 208, can be made up of one or more modules of one or more different types of memory, and may be configured to store data and other information as well as operational instructions that may be used by the processor 206 to image combiner circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a image combiner circuit 210.

Communication circuit 201 either or both a wireless transceiver circuit 202 with an associated antenna 214 and a wired I/O interface 204 with an associated hardwired data port (not illustrated). As this example illustrates, communications with image combiner circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by image combiner circuit 210 to/from other entities such as sensors 52 and vehicle systems 58.

Wired I/O interface 204 can include a transmitter and a receiver (not shown) for hardwired communications with other devices. For example, wired I/O interface 204 can provide a hardwired interface to other components, including sensors 52 and vehicle systems 58. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 52 can include, for example, sensors 52 such as those described above with reference to the example of FIG. 1. Sensors 52 can include additional sensors that may or not otherwise be included on a standard vehicle 10 with which the turn selfie system 200 is implemented. In the illustrated example, sensors 52 may include exterior cameras 214, interior cameras 216, and other sensors 232. Additional sensors 52 can also be included as may be appropriate for a given implementation of selfie system 200.

Vehicle systems 58 can include any of a number of different vehicle components or subsystems used to control or monitor various aspects of the vehicle and its performance. In this example, the vehicle systems 58 include a GPS or other vehicle positioning system 272; vehicle-to-vehicle (V2V) communications system 274, vehicle-to-infrastructure (V2I) communications system 276, and other vehicle systems 282.

During operation, image combiner circuit 210 can receive information from various vehicle sensors to determine whether the selfie mode should be activated. Also, the driver may manually activate the selfie mode by operating the selfie button 205. Communication circuit 201 can be used to transmit and receive information between image combiner circuit 210 and sensors 52, and image combiner circuit 210 and vehicle systems 58. Also, sensors 52 may communicate with vehicle systems 58 directly or indirectly (e.g., via communication circuit 201 or otherwise).

In various embodiments, communication circuit 201 can be configured to receive data and other information from sensors 52 that is used in determining whether to activate the selfie mode. Additionally, communication circuit 201 can be used to send an activation signal or other activation information to various vehicle systems 58 as part of entering the selfie mode. For example, as described in more detail below, communication circuit 201 can be used to send signals to, for example, one or more of: vehicle positioning system 272; V2V communications system 274, V2I communications system 276, and other vehicle systems 282. The decision regarding what action to take via these various vehicle systems 58 can be made based on the information detected by sensors 52. Examples of this are described in more detail below.

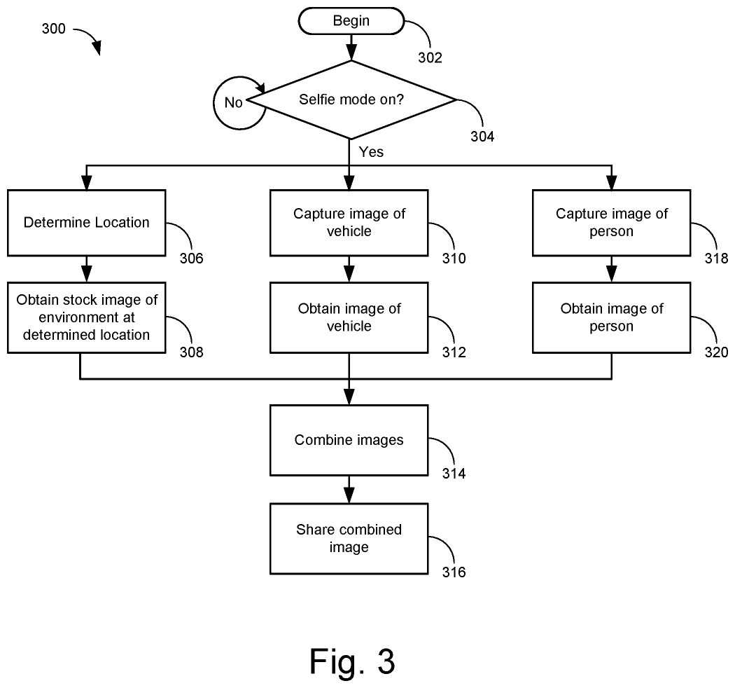

FIG. 3 illustrates a process 300 for a vehicle for automatically creating combined images of the vehicle and a location according to embodiments of the disclosed technology. While elements of the process 300 are described in a particular sequence, it should be understood that certain elements of the process 300 may be performed in other sequences, may be performed concurrently, may be omitted, or any combination thereof. And while the elements of the process 300 are described with reference to the vehicle, it should be understood that in various embodiments, one or more of these elements may be implemented outside the vehicle, for example in a cloud computing environment.

Referring to FIG. 3, the process 300 begins, at 302. The image combiner circuit 210 of the vehicle first may determine whether the selfie mode is on, at 304. This may include determining whether the selfie mode has been activated, for example manually by the driver using the selfie button 205. The image combiner circuit 210 continues this determination until the selfie mode is activated. In some embodiments, the vehicle may activate the selfie mode automatically, for example when the vehicle is started.

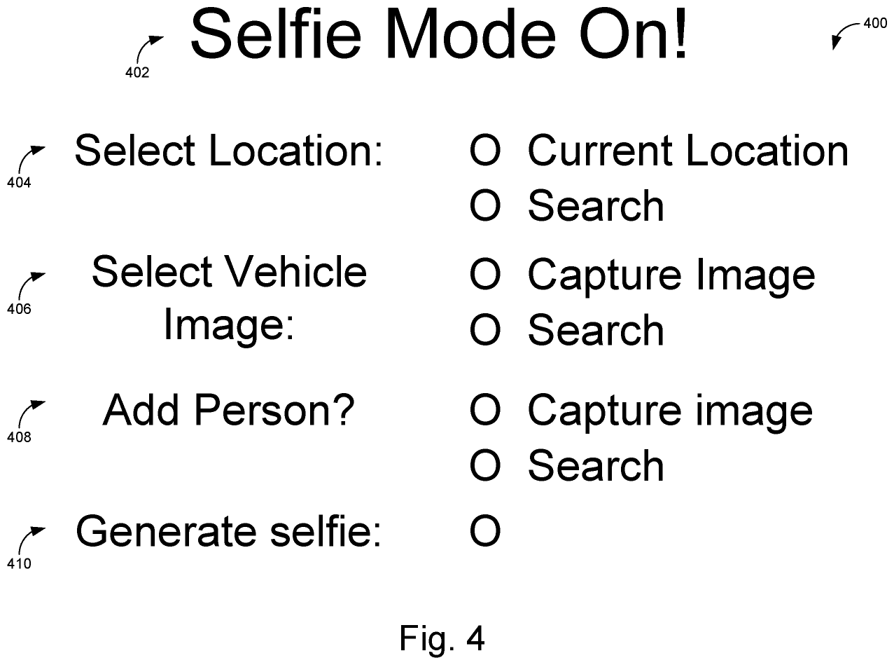

When the selfie mode is active, a display panel of the vehicle may display a corresponding user interface. The display panel may be a touch panel, may be voice-controlled, or the like. FIG. 4 shows an example selfie mode user interface 400 according to embodiments of the disclosed technology. Referring to FIG. 4, the selfie mode user interface may include a banner 402 announcing that the selfie mode is on.

Referring again to FIG. 3, when the selfie mode is activate, the image combiner circuit 210 may determine a location, at 306. In some embodiments, the location may be the current location of the vehicle. In such embodiments, the location of the vehicle may be determined by the vehicle position system 272, or the like. In other embodiments, the user may be prompted to choose a location. Referring again to FIG. 4, in some embodiments, the user interface 400 may prompt the user to select the location, and may provide radio buttons to receive a user selection, at 404. For example, the user may be provided options to use the current location of the vehicle, to search for a different location, or the like. In such embodiments, the image combiner circuit 210 of the vehicle determines the location according to the user input.

Referring again to FIG. 3, after a location is determined, the image combiner circuit 210 may obtain a stock image of the environment related to the location, at 308. For example, the user may select the location as Mount Fuji. In response, the image combiner circuit 210 may obtain a stock image of Mount Fuji. The stock image may be obtained from any storage location. Example storage locations include the vehicle, portable electronic devices such as smart phones, image storage websites, social networking websites, and the like.

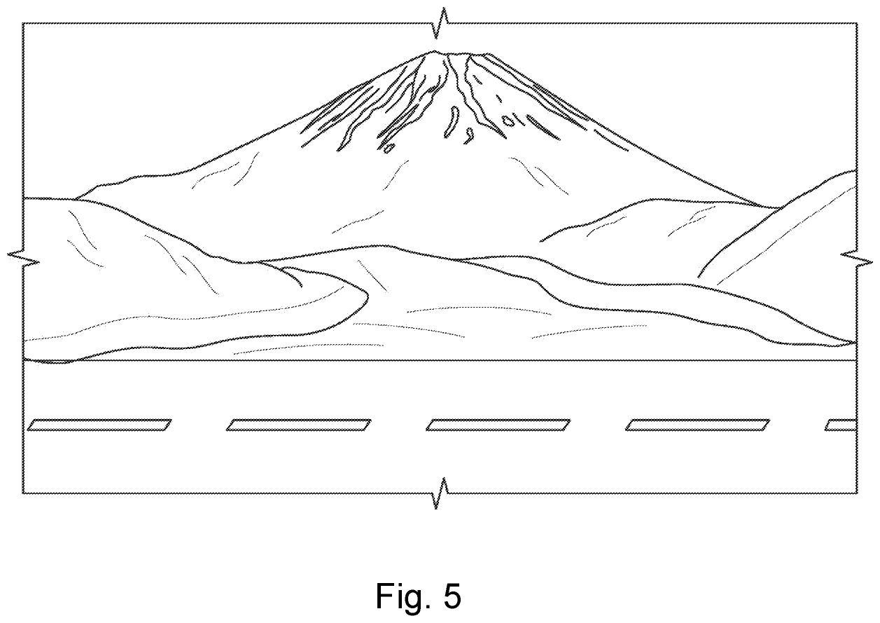

In some embodiments, the image combiner circuit 210 may obtain multiple stock images of the selected location. In such embodiments, the image combiner circuit 210 may prompt the user to select one or more of the images. In some embodiments, the user may select multiple images. In such embodiments, the image combiner circuit 210 may combine the selected images in any manner, for example such as those described elsewhere herein. FIG. 5 illustrates an example stock image of Mount Fuji.

Referring again to FIG. 3, the image combiner circuit 210 may obtain an image of the vehicle, at 312. In various embodiments, the selfie may include other vehicles as well. These embodiments allow a user to include two or more of his vehicles, vehicles of friends, and other vehicles. In such embodiments, the image combiner circuit 210 may obtain images of multiple vehicles.

Referring again to FIG. 4, in some embodiments, the user interface 400 may prompt the user to select the vehicle image, and may provide radio buttons to receive a user selection, at 406. For example, the user may be provided options to capture an image of the vehicle, to search for a different image, or the like. In such embodiments, the image combiner circuit 210 of the vehicle responds according to the user input. For example, the user may elect to search for an image. In response, the image combiner circuit 210 may obtain a stock image of the vehicle. The stock vehicle image may be obtained from any storage location. Example storage locations include the vehicle, portable electronic devices such as smart phones, image storage websites, social networking websites, and the like.

Alternatively, the user may elect to capture an image of the vehicle. In this example, the image combiner circuit 210 captures an image of the vehicle, at 310. For example, one or more exterior cameras 214 of the vehicle may capture one or more images of the vehicle. As another example, one or more interior cameras 216 of the vehicle may capture one or more images of the vehicle. In either case, multiple images of the vehicle may be combined.

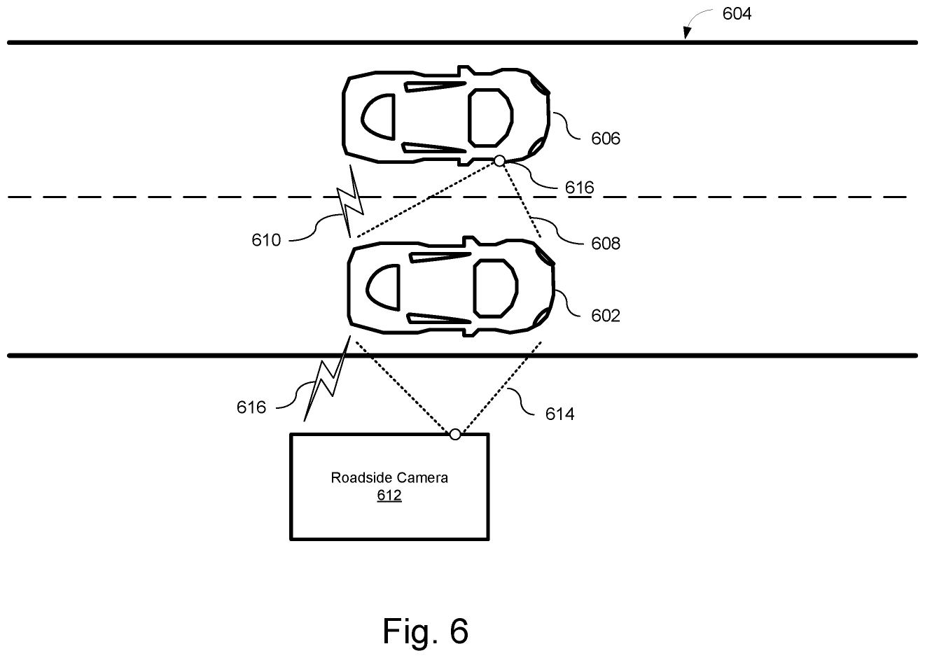

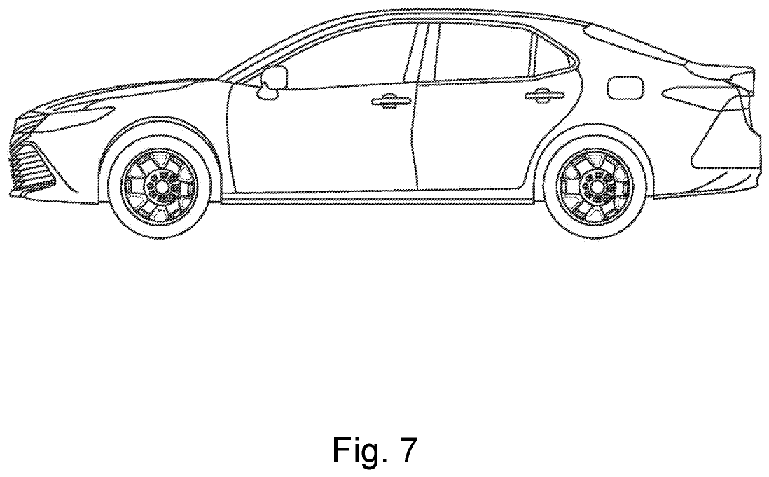

In some embodiments, images of the vehicle may be captured by cameras located beyond the vehicle, and the captured images may be provided to the vehicle. FIG. 6 illustrates scenarios where vehicle images are captured and then relayed to the vehicle according to embodiments of the disclosed technology. Referring to FIG. 6, a vehicle 602 is traveling on a road 604. For clarity, this vehicle 602 is referred to as the “selfie vehicle.” In the described embodiments, the vehicle images are captured while the vehicle is traveling on a roadway. However, the vehicle images may be captured while the vehicle is stationary, while the vehicle is not located on a roadway, or both. FIG. 7 illustrates an example vehicle image.

Referring again to FIG. 6, in some embodiments, the vehicle images may be captured by one or more cameras mounted on another vehicle. In the example of FIG. 6, a second vehicle 606 is traveling near the selfie vehicle 602. Vehicles may communicate wirelessly using vehicle-to-vehicle (V2V) communications or the like, as indicated generally at 610. Using these communications, the selfie vehicle 602 may request the images from the second vehicle 606. The second vehicle 606 may have a camera 616 mounted thereon. The camera 616 on the second vehicle 606 may capture one or more images of the selfie vehicle 602 in response to the request, as indicated generally at 608, and may transmit the images to the selfie vehicle 602, as indicated generally at 610. In some embodiments, the second vehicle 606 may provide images of the selfie vehicle 602 that were captured prior to the request.

In some embodiments, the vehicle images may be captured by one or more roadside cameras. In the example of FIG. 6, a roadside camera 612 may communicate with the selfie vehicle 602 wirelessly, using V2I communications or the like, as indicated generally at 616. Using these communications, the selfie vehicle 602 may request images from the roadside camera 612. In response, the roadside camera 612 may capture one or more images of the selfie vehicle 602, as indicated generally at 614, and may provide the images to the selfie vehicle, as indicated generally at 616. In some embodiments, the roadside camera 612 may provide images of the selfie vehicle 602 that were captured prior to the request.

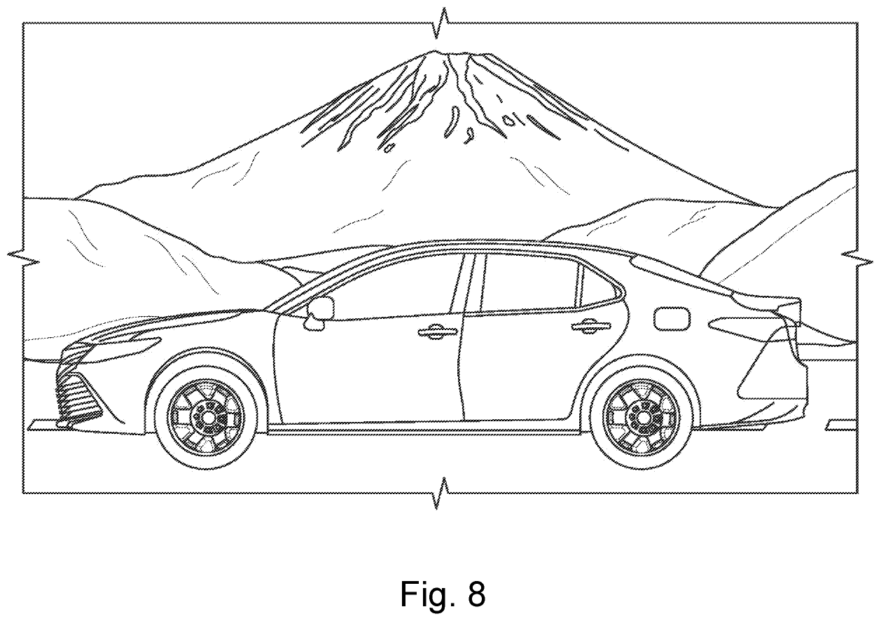

Referring again to FIG. 3, the image combiner circuit 210 may generate a combined image using one or more images of the environment of the location, and one or more images of the vehicle, at 314. The images may be combined in any manner, including the examples given above, and the like. The images may be combined responsive to user operation of the user interface 400 of FIG. 4. For example, referring to FIG. 4, the user may operate a radio button to generate the vehicle selfie, as shown at 410. FIG. 8 illustrates an example vehicle selfie.

Referring again to FIG. 3, the image combiner circuit 210 may share the combined image, at 316. For example, the image combiner circuit 210 may display the combined image on a display panel mounted within the vehicle. The display panel may be the same panel that displayed the user interface 400 of FIG. 4. In this example, the combined image replaces the user interface 400. As another example, the image combiner circuit 210 may share the combined image by transmitting the combined image to another device or service. Example devices and services include portable electronic devices such as smart phones, remote image storage sites, social media services, and the like.

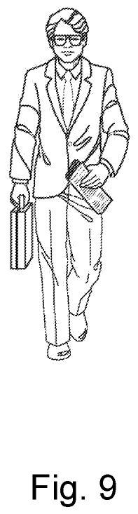

In some embodiments, images of one or more persons may be included in the vehicle selfie. In such embodiments, this inclusion may be selected by the user, for example by operating the user interface 400 of FIG. 4 of the vehicle. Referring again to FIG. 4, the user interface 400 may prompt the user to add a person, at 408. Responsive to the prompt, the user may operate one or more radio buttons. In the example of FIG. 4, the user may operate one radio button to capture a new image, may operate another radio button to search images, or may make no selection by operating neither of the radio buttons, and instead operating the “generate selfie” radio button, at 410. Responsive to the user operating the search radio button, the image combiner circuit 210 allows the user to search for a stock image of the person, for example in a manner similar to searching for vehicle images, as described above. Responsive to the user operating the “capture image” radio button, the image combiner circuit 210 operates one or more of the cameras of the vehicle to capture an image of the user. FIG. 9 illustrates an example image of a person. In some embodiments, the person and the vehicle may be captured in the same image.

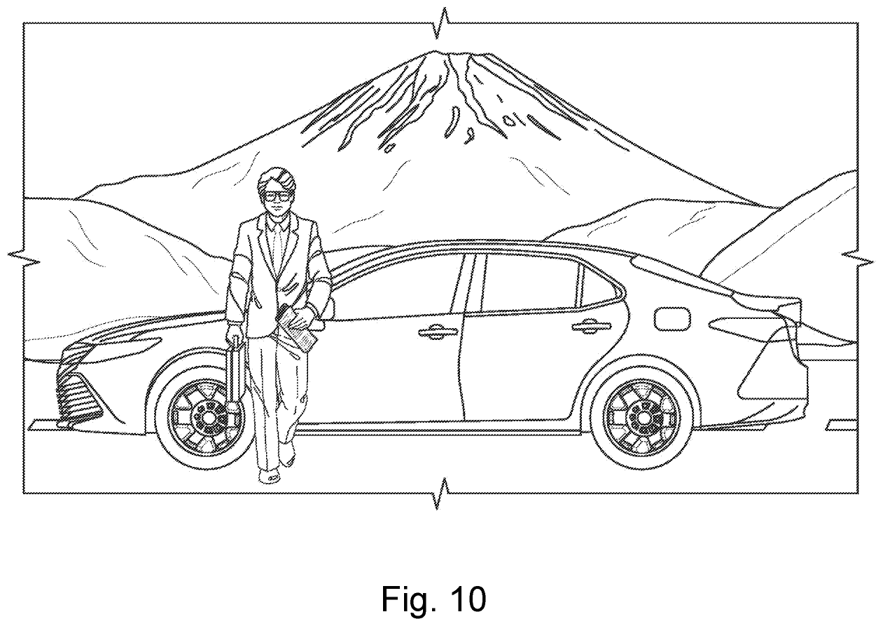

Referring again to FIG. 3, in these embodiments, the image combiner circuit 210 may generate a combined image from one or more images of the person or persons, one or more images of the vehicle, and one or more images of the environment of the determined location, at 314. These images may be combined in a manner, for example as described above, or the like. The image combiner circuit 210 may then share the combined image, at 316, for example as described above, or the like. FIG. 10 illustrates an example vehicle selfie including the image of the person of FIG. 9.

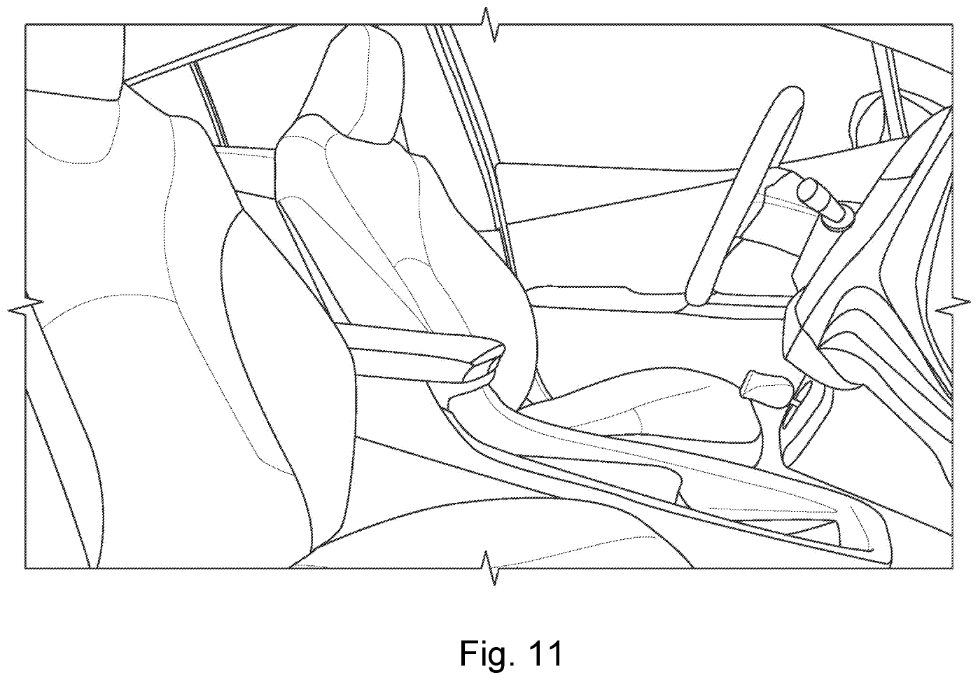

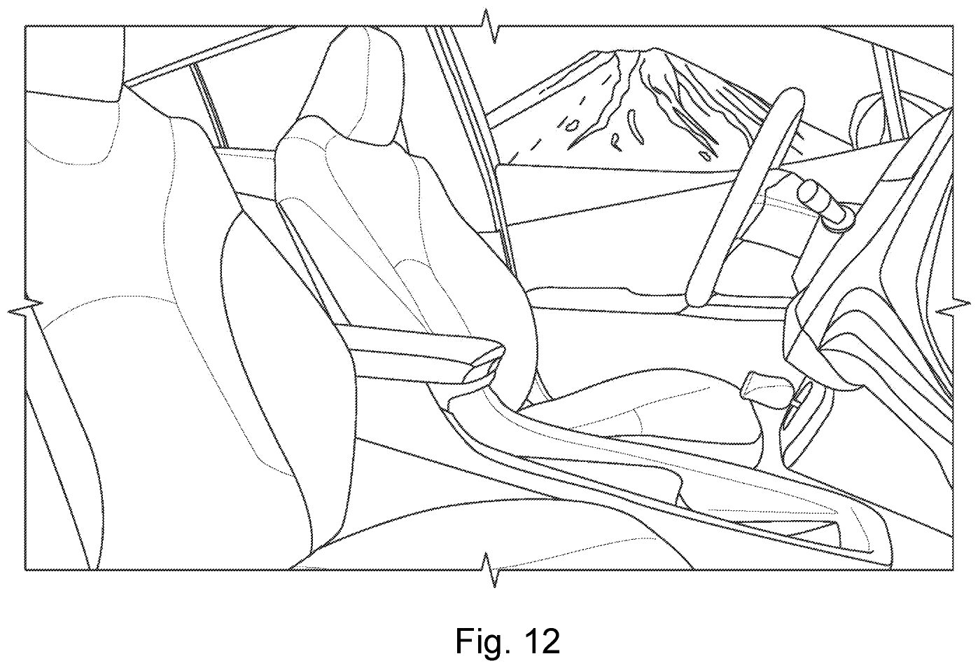

In some embodiments, the image combiner circuit 210 may generate a combined image using an image of the interior of the vehicle. In such embodiments, the image combiner circuit 210 may control one or more of the interior cameras 216 of the vehicle to capture one or more images of the interior of the vehicle. In some embodiments, multiple images from multiple cameras may be combined to generate an image of the interior of the vehicle. FIG. 11 illustrates an example image of the interior of a vehicle. In these embodiments, the image combiner circuit 210 may combine an image of the interior of the vehicle with an image of the environment of the determined location. FIG. 12 illustrates an example combined image of the interior of the vehicle shown in FIG. 11 combined with the image of Mount Fuji of FIG. 5.

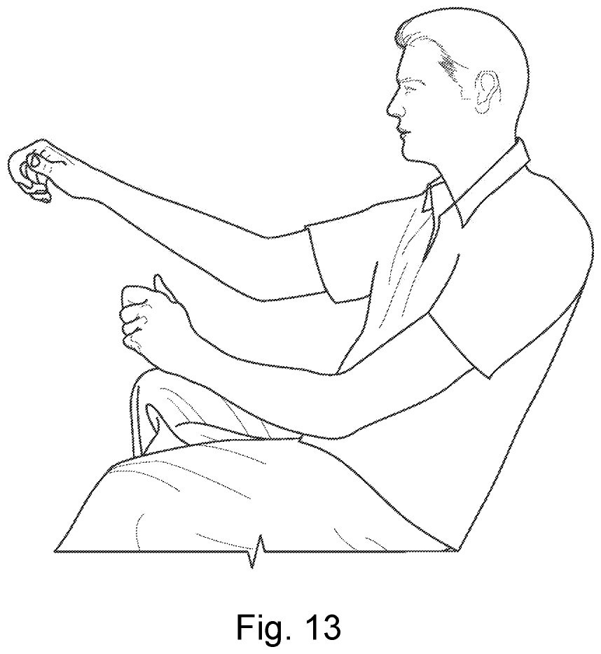

In some of these embodiments, an image of a person may be added to the vehicle selfie. In such embodiments, the image of the person may be captured or may be a stock image. FIG. 13 illustrates an example image of a person. In some embodiments, the person and the interior of the vehicle may be captured in a single image. For example, the image combiner circuit 210 may control one or more of the interior cameras 216 of the vehicle to obtain an image of the person while seated in the vehicle.

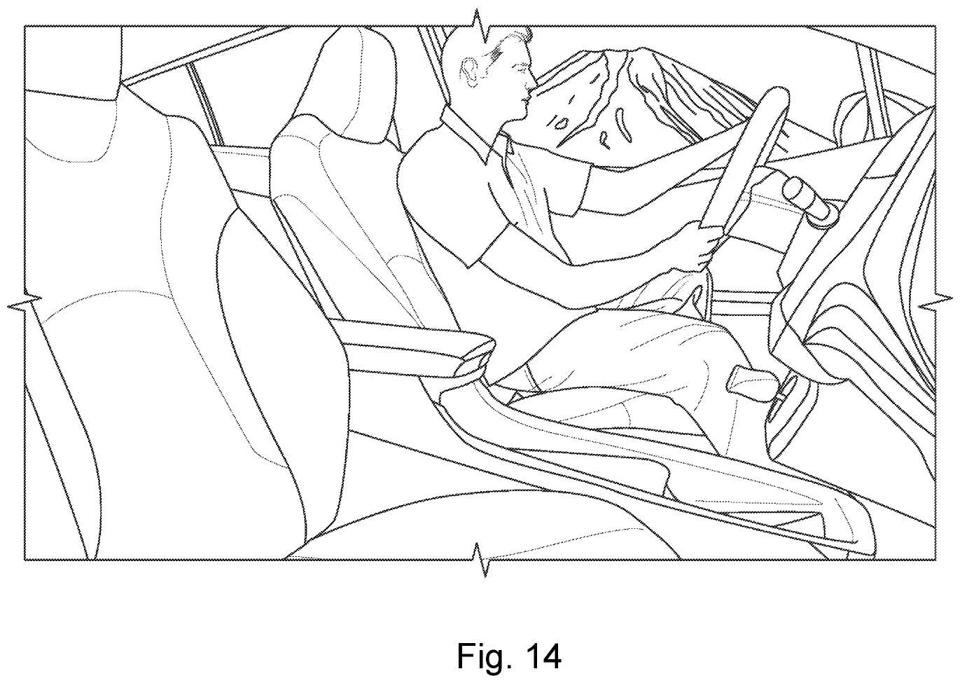

Referring again to FIG. 3, in these embodiments, the image combiner circuit 210 may generate a combined image from one or more images of the person or persons, one or more images of the interior of the vehicle, and one or more images of the environment of the determined location, at 314. These images may be combined in a manner, for example as described above, or the like. The image combiner circuit 210 may then share the combined image, at 316, for example as described above, or the like. FIG. 14 illustrates an example vehicle selfie including the image of the interior of the vehicle of FIG. 11, the image of the person of FIG. 13, and the image of Mount Fuji of FIG. 5.

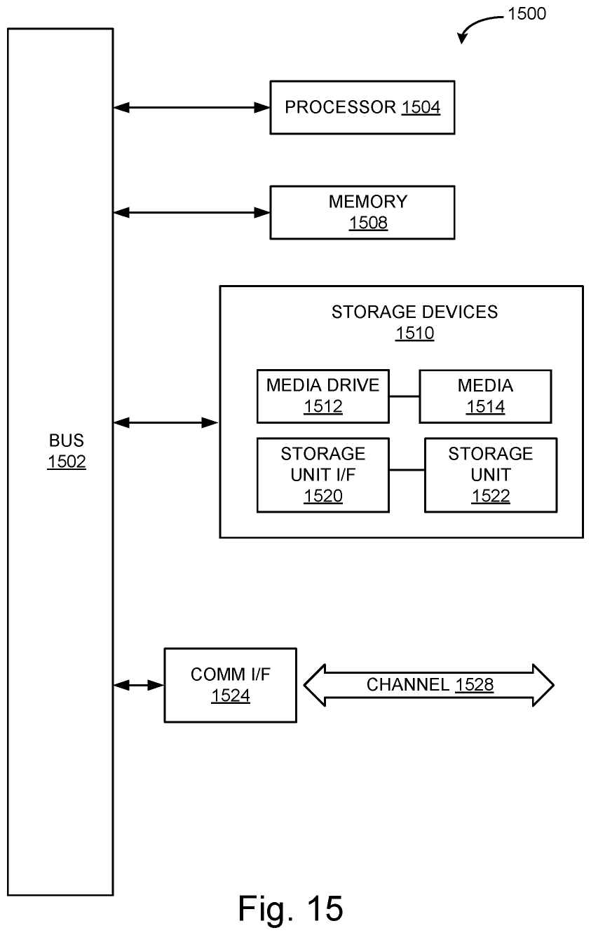

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 15. Various embodiments are described in terms of this example-computing component 1500. After reading this description, it will become apparent to a person skilled in the relevant art how to implement the application using other computing components or architectures.

Referring now to FIG. 15, computing component 1500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1500 might also represent computing capabilities embedded within or otherwise available to a given device. For example, a computing component might be found in other electronic devices such as, for example, portable computing devices, and other electronic devices that might include some form of processing capability.

Computing component 1500 might include, for example, one or more processors, controllers, control components, or other processing devices. This can include a processor 1504. Processor 1504 might be implemented using a general-purpose or special-purpose processing engine such as, for example, a microprocessor, controller, or other control logic. Processor 1504 may be connected to a bus 1502. However, any communication medium can be used to facilitate interaction with other components of computing component 1500 or to communicate externally.

Computing component 1500 might also include one or more memory components, simply referred to herein as main memory 1508. For example, random access memory (RAM) or other dynamic memory, might be used for storing information and instructions to be executed by processor 1504. Main memory 1508 might also be used for storing temporary variables or other intermediate information during execution of instructions to be executed by processor 1504. Computing component 1500 might likewise include a read only memory (“ROM”) or other static storage device coupled to bus 1502 for storing static information and instructions for processor 1504.

The computing component 1500 might also include one or more various forms of information storage mechanism 1510, which might include, for example, a media drive 1512 and a storage unit interface 1520. The media drive 1512 might include a drive or other mechanism to support fixed or removable storage media 1514. For example, a hard disk drive, a solid-state drive, a magnetic tape drive, an optical drive, a compact disc (CD) or digital video disc (DVD) drive (R or RW), or other removable or fixed media drive might be provided. Storage media 1514 might include, for example, a hard disk, an integrated circuit assembly, magnetic tape, cartridge, optical disk, a CD or DVD. Storage media 1514 may be any other fixed or removable medium that is read by, written to or accessed by media drive 1512. As these examples illustrate, the storage media 1514 can include a computer usable storage medium having stored therein computer software or data.

In alternative embodiments, information storage mechanism 1510 might include other similar instrumentalities for allowing computer programs or other instructions or data to be loaded into computing component 1500. Such instrumentalities might include, for example, a fixed or removable storage unit 1522 and an interface 1520. Examples of such storage units 1522 and interfaces 1520 can include a program cartridge and cartridge interface, a removable memory (for example, a flash memory or other removable memory component) and memory slot. Other examples may include a PCMCIA slot and card, and other fixed or removable storage units 1522 and interfaces 1520 that allow software and data to be transferred from storage unit 1522 to computing component 1500.

Computing component 1500 might also include a communications interface 1524. Communications interface 1524 might be used to allow software and data to be transferred between computing component 1500 and external devices. Examples of communications interface 1524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1524 may be carried on signals, which can be electronic, electromagnetic (which includes optical) or other signals capable of being exchanged by a given communications interface 1524. These signals might be provided to communications interface 1524 via a channel 1528. Channel 1528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1508, storage unit 1520, media 1514, and channel 1528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a hardware processor; and
a non-transitory machine-readable storage medium encoded with instructions executable by the hardware processor to perform a method comprising:
determining a location;
obtaining a stock image of an environment related to the location;
obtaining an image of the vehicle;
generating a combined image, comprising combining the stock image of the environment with the image of the vehicle; and
displaying the combined image.

2. The system of claim 1, wherein:
the location is a current location of the vehicle.

3. The system of claim 1, wherein the image of the vehicle is a stock image of the vehicle.

4. The system of claim 1, the method further comprising:
capturing the image of the vehicle.

5. The system of claim 1, the method further comprising:
obtaining an image of person;
wherein generating the combined image comprises combining the image of the environment, the image of the vehicle, and the image of the person.

6. The system of claim 5, the method further comprising:
capturing the image of the person.

7. The system of claim 6, wherein:
the vehicle includes one or more cameras; and
capturing the image of the person comprises capturing the image of the person using the one or more cameras of the vehicle.

8. A non-transitory machine-readable storage medium encoded with instructions executable by the hardware processor to perform a method comprising:
determining a location;
obtaining a stock image of an environment related to the location;
obtaining an image of the vehicle;
generating a combined image, comprising combining the stock image of the environment with the image of the vehicle; and
displaying the combined image.

9. The medium of claim 1, wherein:
the location is a current location of the vehicle.

10. The medium of claim 1, wherein the image of the vehicle is a stock image of the vehicle.

11. The medium of claim 1, the method further comprising:
capturing the image of the vehicle.

12. The medium of claim 1, the method further comprising:
obtaining an image of person;
wherein generating the combined image comprises combining the image of the environment, the image of the vehicle, and the image of the person.

13. The medium of claim 5, the method further comprising:
capturing the image of the person.

14. The medium of claim 6, wherein:
the vehicle includes one or more cameras; and
capturing the image of the person comprises capturing the image of the person using the one or more cameras of the vehicle.

15. A method for a vehicle, comprising:
determining a location;
obtaining a stock image of an environment related to the location;
obtaining an image of the vehicle;
generating a combined image, comprising combining the stock image of the environment with the image of the vehicle; and
displaying the combined image.

16. The method of claim 1, wherein:
the location is a current location of the vehicle.

17. The method of claim 1, wherein the image of the vehicle is a stock image of the vehicle.

18. The method of claim 1, further comprising:
capturing the image of the vehicle.

19. The method of claim 1, further comprising:
obtaining an image of person;
wherein generating the combined image comprises combining the image of the environment, the image of the vehicle, and the image of the person.

20. The method of claim 5, further comprising:
capturing the image of the person.
